(19) United States
(12) Patent Application Publication
(10) Pub. No.: US 2006/0253360 A1
(43) Pub. Date: Nov. 9, 2006

(54) Methods and systems for replicating an index with liquid instruments

(75) Inventor: Anthony Simon Gould, Short Hills, NJ (US)

Correspondence Address: MORGAN LEWIS & BOCKIUS LLP, 1111 PENNSYLVANIA AVENUE NW, WASHINGTON, DC, 20004, US

(73) Assignee: Lehman Brothers Inc., New York, NY (US)

(21) Appl. No.: 11/410,690

(22) Filed: Apr. 24, 2006

Related U.S. Application Data
(60) Provisional application No. 60/674,358, filed on Apr. 22, 2005.
(60) Provisional application No. 60/696,111, filed on Jul. 1, 2005.

(51) Int. Cl. G06Q 40/00

(52) U.S. Cl. 705/35

(57) ABSTRACT

In at least one aspect, the invention comprises a method for replicating a first index, comprising: constructing a basket of derivative financial instruments selected to replicate said index; wherein said basket of derivative financial instruments is constructed using key rate duration matching based on a plurality of instruments, and wherein said basket is reconstructed on a periodic basis approximately equal to that on which said index is reconstructed. In another aspect, the invention comprises a method for replicating a portfolio of securities, comprising: constructing a basket of derivative financial instruments selected to replicate said portfolio; wherein said basket of derivative financial instruments is constructed using key rate duration matching based on a plurality of instruments, and wherein said basket is reconstructed on a periodic basis approximately equal to that on which said portfolio is reconstructed.

### CROSS-REFERENCE TO RELATED APPLICATIONS

This application claims the benefit of U.S. Provisional Application No. 60/674,358, filed Apr. 22, 2005, and the benefit of U.S. Provisional Application No. 60/696,111, filed Jul. 1, 2005. The entire contents of those two provisional applications are incorporated herein by reference.

### BACKGROUND AND SUMMARY

Many bond indices contain a large number of securities, many of which are illiquid or simply not available in the secondary bond market. Consequently, simply acquiring the indexed securities in order to replicate the index is not feasible. Even if one could buy the securities in the secondary market, transaction costs would be prohibitive in obtaining index returns. Thus, bond index managers must find other ways to generate index returns while minimizing risk.

Index replication is not just for passive managers of fixed-income portfolios. Active managers, managers of balanced fixed-income and equity portfolios, and plan sponsors all may wish to replicate the returns on, say, the Lehman Brothers U.S. Aggregate Index or its sub-components. (An overview of the Lehman Brothers U.S. Aggregate Index is provided in Appendix I.) While index replication has been of interest to a small group of managers for a number of years, there recently has been a substantial increase in interest in replication strategies. Though a desire to achieve index returns is a perfectly reasonable goal of replication, demand for replication strategies has been driven primarily by two very different needs.

First, low yields in fixed income markets and concerns over the likely future performance of equity markets have spawned a “rush for alpha.” (Alpha, as strictly defined by the Capital Asset Pricing Model, is the part of the return that is not explained by exposure to the relevant asset class.) This trend has manifested itself in a surge of inflows to hedge funds, but a side effect of this trend has been a broadening interest in “portable alpha” strategies. Typically, a portable alpha strategy involves the transfer of alpha from one asset class to another. For example, an equity manager uses equity futures to eliminate the “beta” from stock market exposure, but preserves the alpha. The manager then uses non-cash instruments to achieve the desired bond market exposure (e.g., matching the Lehman Brothers Aggregate Index).

Second, the increasing use of the Global Aggregate Index, a broad index of investment grade multi-currency fixed-income securities, has caused many managers to look for strategies to replicate its sub-components. A European-based manager may be adept at managing European credit and government securities, but may have less resources or expertise in managing U.S. fixed income. In particular, some non-U.S. managers may choose to refrain from offering a Global Aggregate product because they doubt their ability to manage U.S. mortgage-backed securities effectively. Since the Global Aggregate Index is fast becoming the benchmark of choice for many sponsors, such managers may be forced to forgo the possibility of participating in much of the growth in global fixed-income assignments. Instead, a strategy of replicating segments of the U.S. (and/or Global) Aggregate Index can allow such a manager to offer a Global Aggregate product. Indeed, derivatives can be used to create a “portable alpha” strategy for the Global Aggregate, in which the alpha from a 100% Euro fixed income portfolio is “transported” to a Global Aggregate Index.

There are additional reasons to replicate index returns. A U.S. fixed-income active manager who possesses skill in one aspect of fixed-income management (e.g., credit allocation) may wish to offer the return of the Lehman Brothers Aggregate Index by replicating the return on the mortgage sector. Alternatively, this manager may, at any particular time, wish to eliminate the active risk in a given sector, either because the outlook for a given sector is neutral or because of a low level of confidence in a given view.

Plan sponsors engaged in asset allocation shifts are increasingly using transition managers to minimize implementation shortfall. Such transitions can involve transactions in multiple asset classes spread across more than a week. If the target portfolio is fixed income, it may be optimal to gain the desired exposure to fixed income at the beginning of the transition, before the liquidation of assets has even begun. If the legacy portfolio is fixed income, there may be a desire to retain fixed-income exposure throughout the transition. In both cases, a replicating portfolio of derivative instruments can achieve these objectives.

Similarly, asset managers may use replication strategies to manage portfolio inflows and outflows. For example, following an inflow, it may take days for new bonds to be purchased. A replicating portfolio of derivatives can maintain market exposure on uninvested cash. Similarly, a replicating portfolio can maintain market exposure in the period between the sale and settlement of securities liquidated to meet a portfolio outflow.

Replication Methods

Methods of replicating bond indices generally fall into three categories: replication with cash instruments (i.e., bonds, not derivative instruments), replication with derivatives, and total-return index swaps.

Replication with cash instruments is an appropriate strategy in two kinds of situations. First, passive managers will generally use cash instruments to achieve very low return deviations from benchmark. This strategy makes sense for large portfolios with hundreds of holdings, for which the goal is pure indexation and the portfolio is fully funded. Second, active managers may wish to replicate that part of the benchmark for which they do not possess skill. In this case, however, using derivative instruments may be preferable, to permit the managers to exercise skill in other sectors (thereby generating alpha from 100% of portfolio assets). Cash replications are typically done using a stratified sampling approach, in which the index is dissected into cells and bonds are selected to represent the characteristics of each cell.

Managers who do not wish to use cash instruments, but also are not willing to manage a portfolio of derivative instruments, may choose to use total-return index swaps. FIG. 1 shows an example of a total return swap.

Under a total return swap, the investor is guaranteed to receive the total return on the index selected, in return for paying the counterparty floating-rate LIBOR, plus a spread, to compensate the dealer for the risk in hedging the index exposure. (Under the swap, the basis risk between a given replicating strategy and the index is effectively borne by the dealer, who is compensated for it by the investor.) This approach is appropriate for investors with a high degree of risk aversion or those with relatively long (one year and longer) time horizons, owing to the limited liquidity and higher transaction costs associated with a swap.

In most other situations, replication with derivative instruments is likely to be preferable, and this method is used in at least one embodiment of the present invention. Derivative instruments are highly liquid, have low transaction costs, and are unfunded instruments. While there may be some basis risk between the derivative and underlying instruments, this risk is likely to be lower than the level of security-specific risk that a portfolio of actively managed cash instruments would typically possess.

Various methods of index replication for both U.S. and global indices are known (see references below). These include replication of the U.S. Aggregate and sub-indices with futures alone, as well as futures and swaps, replication of the U.S. MBS Index with TBAs or large pools, and replication of the Global Aggregate with both derivatives and cash instruments. MBS stands for Mortgage Backed Securities; TBA stands for To Be Announced, and refers to the generic forward market for mortgage backed securities. In this market, a coupon, par quantity, agency, maturity, and coupon characteristics are indicated, but the exact details, such as specific pools, are to be formalized at a later time. TBAs are discussed in more detail in Appendix II.

Sources of Risk in the Lehman Brothers Aggregate Index

In considering the merits of various replication strategies, we should examine the sources of volatility in the U.S. Aggregate Index. Table 1 shows output from the Lehman Brothers Risk Model, which breaks down the sources of risk for the Lehman Brothers Aggregate Index and various sub-components. Details of the risk model are provided in “The Lehman Brothers Global Risk Model: A portfolio manager's guide”, March 2005, accessible on LehmanLive Specifications of the MBS Risk Model and the Credit Risk Model are also accessible from Lehman Live.

TABLE 1
Sources of Risk in Lehman Brothers Indices, bp per month

| Global Risk | U.S. | | | |
|---|---|---|---|---|
| Factor | Aggregate | U.S. Treasury | U.S. MBS | U.S. Credit |
| Yield Curve | 150.03 | 141.78 | 77.65 | 150.91 |
| Swap Spreads | 19.73 | 18.01 | 33.88 | |
| Volatility | 7.34 | 0.06 | 10.33 | 0.30 |
| Investment- | 19.02 | 7.40 | 22.01 | 57.01 |
| Grade Spreads | | | | |
| Treasury Spreads | 0.79 | 7.40 | | |
| Credit and | 15.76 | 57.01 | | |
| Agency Spreads | | | | |
| MBS/Securitized | 7.81 | 22.01 | | |
| CMBS/ABS | 0.89 | | | |
| Systematic Risk | 146.79 | 139.36 | 80.43 | 145.75 |
| Idiosyncratic | 2.74 | 0.61 | 2.83 | 7.89 |
| Risk | | | | |
| Total Risk (bp | 146.81 | 139.36 | 80.48 | 145.96 |
| per month) | | | | |

The Lehman Brothers Multi-Factor Risk Model quantifies the ex-ante tracking error volatility (the expected volatility of the return deviation) of a portfolio versus its benchmark or the absolute volatility of a portfolio or index. The model is based on the historical returns of individual securities in the Lehman Brothers Bond Indices, in many instances dating back over more than a decade. The model derives historical magnitudes of different market risk factors and the relationships among them. It then measures current mismatches between the portfolio and benchmark sensitivities to these risks and multiplies these mismatches by historical volatilities and correlations (“covariance matrix”) to produce its output.

While tracking error volatility (TEV) is a measure of volatility, it can be used (with caution) to make forecasts of the likely distribution of future relative returns. For example, assuming returns are normally distributed, a portfolio with a TEV of 25 bp per month would be expected to have a return within +/−25 bp per month around the expected return difference between the portfolio and benchmark approximately two thirds of the time (and underperformance of worse than −25 bp relative to the expected return difference one-sixth of the time).

The total volatility of a given index reflects the risk due to exposure to various risk factors and correlations between risk factors. Accordingly, the volatilities are not additive. The expected volatility of a given index can be expressed as a function of its exposures to risk factors and the volatility of those factors. The credit index (or an individual credit security) will be exposed to term structure risk, swap spread risk, credit spread risk (together, “systematic risk”), and idiosyncratic risk.

The risk characteristics of a given index determine which instruments can best replicate that index. For U.S. investment-grade fixed-income indices, term structure is by far the dominant source of risk. Therefore, a portfolio of treasury futures, matched as closely as possible to the duration characteristics of the relevant index, should be able to attain a reasonable replication result. For mortgage-backed securities, swap spread risk is almost as important as MBS spread risk. Therefore, receiving fixed-rate interest rate swaps might be expected to achieve a better replication result than using treasury futures. For credit, while swaps would also be expected to achieve improved replication, additional instruments would be needed to reduce credit spread risk to achieve replication results closer to those of other sectors.

In one aspect, the invention comprises a method for replicating a first index, comprising: constructing a basket of derivative financial instruments selected to replicate said index; wherein said basket of derivative financial instruments is constructed using key rate duration matching based on a plurality of instruments, and wherein said basket is reconstructed on a periodic basis approximately equal to that on which said index is reconstructed.

In various embodiments: (1) said plurality equals the number of types of duration of instruments in said index; (2) said first index is a fixed income index; (3) said derivative financial instruments comprise treasury futures; (4) said derivative financial instruments comprise interest rate swaps; (5) said derivative financial instruments comprise CDX products; (6) said derivative financial instruments comprise credit default swaps; (7) said basket comprises a second index; and (8) the method further comprises providing a total return swap, wherein a purchaser of said swap is guaranteed a return equivalent to that of said index.

In another aspect, the invention comprises offering a total return swap for sale, wherein said total return swap is as described above.

In another aspect, the invention comprises a method comprising offering a basket of derivative financial instruments for sale, wherein said basket of derivative financial instruments is as described above.

In another aspect, the invention comprises a method for replicating a portfolio of securities, comprising: constructing a basket of derivative financial instruments selected to replicate said portfolio; wherein said basket of derivative financial instruments is constructed using key rate duration matching based on a plurality of instruments, and wherein said basket is reconstructed on a periodic basis approximately equal to that on which said portfolio is reconstructed.

In various embodiments: (1) said plurality equals the number of types of duration of instruments in said index; (2) said first index is a fixed income index; (3) said derivative financial instruments comprise treasury futures; (4) said derivative financial instruments comprise interest rate swaps; (5) said derivative financial instruments comprise CDX products; (6) said derivative financial instruments comprise credit default swaps; (7) wherein said basket comprises a second index; and (8) the method further comprises providing a total return swap, wherein a purchaser of said swap is guaranteed a return equivalent to that of said index.

In another aspect, the invention comprises offering a total return swap for sale, wherein said total return swap is as described above.

In another aspect, the invention comprises offering a basket of derivative financial instruments for sale, wherein said basket of derivative financial instruments is as described above.

Embodiments of the present invention comprise mathematical models, computer components and computer-implemented steps that will be apparent to those skilled in the art. For ease of exposition, not every step or element of the present invention is described herein as part of a computer system, but those skilled in the art will recognize that each step or element may have a corresponding mathematical model, computer system or software component. Such computer system and/or software components are therefore enabled by describing their corresponding steps or elements (that is, their functionality), and are within the scope of the present invention.

The present invention comprises a methodology, described below, for replicating a fixed income index or portfolio. The indices include, but are not limited to:

The Lehman Global Aggregate Bond index and all of its subindices

The Lehman U.S. Aggregate Bond Index and all of its subindices

The Lehman Pan-European Aggregate Bond Index and all of its subindices

The Lehman Asia Pacific Aggregate Bond Index and all of its subindices

The Lehman Global Treasury Index and all of its subindices

The Lehman Multiverse Index and all of its subindices.

A description of each index is provided in Reference 13.

### BRIEF DESCRIPTION OF THE DRAWINGS

FIG. 1 depicts a total return swap on the Lehman Brothers Aggregate Index.

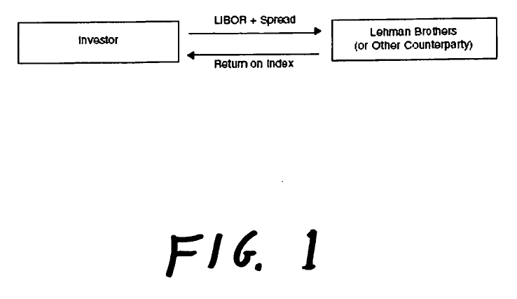

FIG. 2 depicts option-adjusted spreads for the U.S. Credit and Mirror Swap Credit Index.

FIG. 3 depicts option-adjusted spread of current coupon FNCL 30-year MBS versus 5-year swap spread.

FIG. 4 depicts a relationship between credit spreads and CDS.

FIG. 5a depicts realized return differences of MBS replication and credit replication.

FIG. 5b depicts realized return differences of “full” aggregate replication strategy.

FIG. 6 depicts changes in the sectoral distribution of the Lehman U.S. Aggregate Index over time.

FIG. 7 depicts the sectoral distribution of the Lehman U.S. Aggregate Index.

FIG. 8 depicts the distribution of the Lehman U.S. Aggregate Index by quality (rating).

FIG. 9 depicts mechanics of a typical default swap.

### DETAILED DESCRIPTION OF PREFERRED EMBODIMENTS

Preferred Derivatives Replication Strategy

An examination of the sources of risk in various indices indicates that a replicating portfolio that matches the systematic exposure of these indices might achieve reasonable results in delivering acceptably low levels of tracking error. However, there are at least two categories of choices in building such a portfolio: a choice of instruments and a choice of replication technique. See Table 2.

TABLE 2
Decisions in Forming a Replication Strategy with Derivative Instruments

Instruments
Bond Futures
Interest-Rate Futures
Interest-Rate Swaps
Mortgage TBAs
Credit-Default Swaps
Replication Techniques
Stratified Sampling (Cell Matching)
Key-Rate Duration Matching
Minimum Variance Hedge

Approaches to Replicating Exposures

There are three main approaches to replication:

A stratified sampling approach divides the index into duration cells. A derivative instrument is selected for each cell, in an amount to match the duration exposure of that cell.

A key-rate duration (KRD) approach attempts to match the overall key-rate duration exposures of the index. Key-rate duration measures sensitivity to shifts at specific “key-rate” points along the yield curve (and can therefore measure the effect of non-parallel yield curve shifts), in comparison with “conventional duration,” which measures sensitivity to parallel yield curve shifts.

A minimum-variance hedge approach, with the help of a risk model, seeks to minimize the predicted tracking error of a replicating portfolio against its index. Therefore, the replicating portfolio reflects correlations between sectors and instruments in the portfolio and index—for example, between corporate and government bonds.

Previous replication studies have used a stratified sampling approach. Since 2001, KRDs have been used, and in a recent study (“Replicating Index Returns with Treasury Futures: Duration Cells versus Key-Rate Durations,” Global Relative Value, July 2004), it was demonstrated that such an approach has delivered modestly lower tracking errors than the stratified sampling approach. The regression hedge approach is more model-driven and less transparent than the other two approaches. Furthermore, it is reliant on the relationships between different risk factors—for example, between term structure movements and credit spread changes, which change over time. At least some embodiments of the present invention comprise various replication strategies using the KRD-matching approach.

In the Lehman Brothers Yield Curve Model, there are six key rates (see Table 3). In some cases, however, there are fewer than six instruments available for replication (e.g., replication with Treasury futures, for which there are only four separate instruments). Accordingly, it is not feasible to match all six key-rate durations.

TABLE 3
Key-Rate Durations of Treasury Futures Contracts as of Aug. 31, 2004

| | Key-Rate Duration | | | | | |
|---|---|---|---|---|---|---|
| Contract | 6-Mo | 2-Yr | 5-Yr | 10-Yr | 20-Yr | 30-Yr |
| 2-Year- | 0.07 | 1.97 | 0.06 | 0.00 | 0.00 | 0.00 |
| 5-Year | 0.00 | 0.70 | 3.55 | 0.00 | 0.00 | 0.00 |
| 10-Year | 0.01 | 0.05 | 3.41 | 2.85 | 0.00 | 0.00 |
| Long Bond | 0.01 | 0.05 | 0.23 | 2.65 | 8.16 | 0.61 |

Replication Strategies

Replication with Treasury Futures

The number of bond futures contracts available—the 2-year, 5-year, 10-year, and long contracts—is not sufficient to achieve a perfect match of the six KRDs in the Lehman Brothers Yield Curve Model. There are two possible choices for dealing with this issue. First, an optimization can be established to minimize the sum of the squared differences between the respective index and the replicating portfolio KRDs. However, a preferred embodiment uses a second method, reducing the number of key-rates to equal the number of available instruments in order to achieve a perfect match, by combining the 6-month and 2-year key-rate durations and the 20- and 30-year KRDs. As Table 3 demonstrates, the keyrate duration exposure of the bond futures contracts is minimal for the 6-month rate, while only the long bond contract has any exposure to the 20- or 30-year rate. Nevertheless, there will still be an unavoidable mismatch between the duration exposure of the futures replicating portfolio and the Aggregate Index. The sum of the KRDs of the 20- and 30-year vertices can be matched with a single instrument, but the KRD exposure of both vertices cannot be matched separately.

Replication with Interest Rate Swaps

The fixed-rate leg of an interest-rate swap represents the average of forward rates, which reflect the credit quality of the panel of banks that set the LIBOR rates. Therefore, the pricing of interest-rate swaps reflects a credit risk premium, while their spread to treasuries will also reflect a liquidity premium. Accordingly, receiving the fixed component of an interest-rate swap would be expected to provide a better alternative to replicating the returns of non-Treasury components of the Aggregate Index. In addition, since the swap curve is effectively continuous, one may select six instruments to match exactly the key-rate duration profile of the Aggregate Index.

The historical relationships between yields on various indices and on portfolios of duration-matched interest rate swaps can be examined using the Lehman Brothers Mirror Swaps Indices. The Mirror Swap Index is a portfolio of interest rate swaps (receiving fixed) constructed to match the key-rate duration profiles of various Lehman Brothers indices. For more details, see “The Lehman Brothers Swaps Indices,” January 2002.

In addition, for investors who do not wish to enter several interest-rate swaps, Lehman Brothers offers a total-return swap on various Mirror Swap Indices. This also eliminates the need to rebalance the portfolio to bring duration exposures back in line as the index changes from month to month and swap instruments age.

Replication with Futures and Interest Rate Swaps

An extension of the futures and swaps replication is to use treasury futures to replicate the treasury sector, and swaps to replicate the non-treasury sectors. For this strategy, the term-structure replication error of the treasury component (see above) can be eliminated using swaps.

Replication of the MBS Index with TBAs

The mortgage-backed securities (MBS) sector represents a large component of the Aggregate Index. The availability of liquid instruments to replicate the index and a straightforward method for doing so suggests that such an approach should not greatly increase the complexity relative to a futures-only or swaps-only replication. While futures and swaps can replicate the yield curve exposures of the MBS index, they leave exposure to MBS spread, prepayment, and volatility effects. Using a mortgage product can improve the replication considerably by hedging these exposures as well. TBAs offer two key advantages over MBS pools in replication strategies: they are suitable for an unfunded strategy-since no cash outlay is required, prior to settlement a TBA is simply rolled from month to month; and the back-office aspects of investing in mortgages are much simpler for TBAs than for pools, since monthly interest payments and principal paydowns are avoided. The remaining risk in a TBA replication is essentially due to the difference in risk characteristics between new and seasoned mortgages. See Appendix II for more details.

Replication of the Credit Index with CDS and Interest Rate Swaps

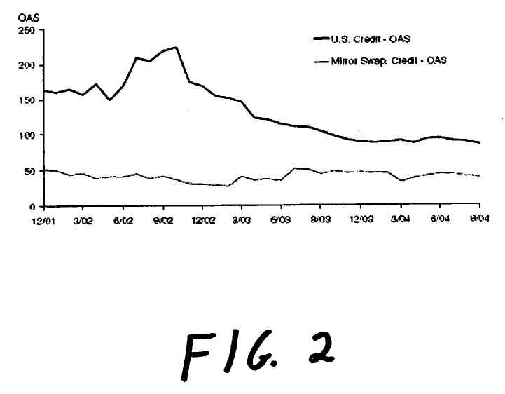

While interest-rate swap spreads are at times highly correlated with credit spreads, there have been extended periods during which this relationship has broken down. In such periods, LIBOR spreads have typically remained quite stable while credit spreads have been quite volatile. For example, FIG. 2 shows that 2002 was a period of great volatility for credit spreads, while swap spreads, as measured by the Mirror Swap Credit Index, were relatively stable. A review of credit-default swaps is provided in Appendix III.

Portfolio credit default swap (CDS) baskets now provide a very liquid instrument that investors can use to take a long (or short) position in credit. Credit yields can be broken down into two constituents: the swap yield and a credit spread to swaps. Accordingly, one can match the exposure of credit to movements in swap yields using interest-rate swaps and the exposure to movements in LIBOR credit spreads by using CDS. The widely traded CDX.NA.IG products are baskets of 125 equally weighted CDS available in 5- and 10-year maturities. In at least one embodiment, 5- and 10-year CDX products are combined in proportions sufficient to match the spread duration and yield of the Credit Index. CDS and CDX are discussed in more detail in Appendix III.

Since these instruments have been available only since October 2003, a period of stable credit spreads, it is difficult to gauge the benefits of including them in a credit index replication strategy. Therefore, one embodiment supplements the CDX data by valuing portfolios of CDS instruments constructed from the issuers that composed the CDX basket as of October 2003, for the period June 2002 to September 2003. A look-forward bias is introduced by doing this. CDX-IG by construction comprises investment-grade-only issuers. In constructing a basket in October 2003 valued back to July 2002, one is certain to avoid some issuers that were downgraded over the period that may have been included in a basket actually constructed in 2002. A large number of names in the basket (e.g., 125) mitigates this risk. During the period, EP and AHOLD were investment-grade issuers that were downgraded to high yield that might reasonably have been expected to have been included in a CDS basket. They represented 0.4% and 0.1% of the Credit Index, respectively, in the month prior to downgrade. In addition to the basis risk that exists between CDS and credit, there is an additional basis that exists between CDX and the underlying CDS.

Performance Summary of Replication Strategies

The key metric by which at least one embodiment measures the performance of various replication strategies is tracking error volatility (TEV). This is preferable to using average out (under) performance for several reasons. The volatility of returns tends to be much more persistent than the returns themselves; that is, history is a much better guide for predicting volatility than for predicting return. Also, it is unlikely that a period of substantial underperformance of a given replication strategy will persist, since this would imply a secular cheapening in a group of highly liquid derivative instruments, or a secular trend in credit or MBS spreads. Finally, the objective of any replication strategy is to replicate the index, not outperform. Outperformance is what active managers are paid for. Nevertheless, mean outperformance of each replicating strategy is reported herein, in order to give a flavor for the degrees of out (under) performance.

Table 4 shows the results of replicating the Lehman Brothers Aggregate Index and selected sub-indices using the approaches described above. The replication of the Treasury Index with treasury futures achieves an acceptable TEV of 10.6 bp per month. Over this period, the futures portfolio outperformed the Treasury Index. This is consistent with prior studies that showed mean outperformance of 3.1 bp per month over three separate time periods. See “Hedging and Replication of Fixed Income Portfolios,” Dynkin et al., Journal of Portfolio Management, March 2002. This reflects two effects. This replication assumes that cash is invested at LIBOR, which over the past two years has had a 1.8 bp per month higher yield than treasury bills. The residual outperfomance suggests that the premium that long futures positions enjoy for being short the cash bond delivery option has been “too large” over these periods.

Treasury futures fare less well, as expected, as instruments to replicate MBS and Credit Indices. While term structure risk is reduced, spread risk remains. Prior studies have found that interest-rate swaps delivered measurable reductions in tracking error compared with Treasury futures when replicating the MBS and Credit Indices. In the most recent period, however, while swaps deliver lower TEV against the Credit Index, they have a higher TEV for replication of the MBS Index compared with using Treasury futures.

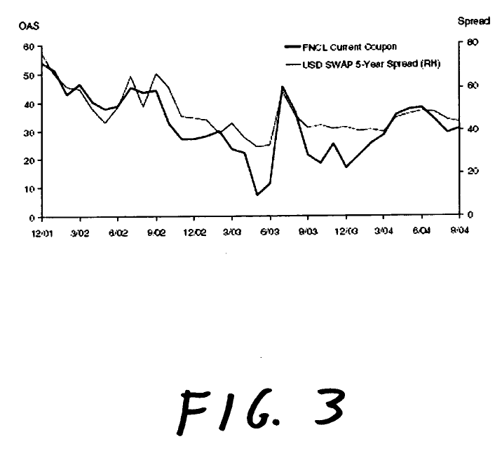

FIG. 3 shows that there has been a close relationship between mortgage spreads and swap spreads, so it might seem that swaps should have performed better than futures. The replication results suggest, however, that other factors are responsible for this effect. In recent years, swaps have been a favored tool for the convexity hedging of MBS securities, and therefore swap spreads have tended to behave directionally, tightening as Treasury yields fall and widening as they rise. Therefore, using swaps in a replication in place of treasury futures may increase the effective duration mismatch of the replication strategy. An additional factor is the optionality of MBS and futures. A buyer of futures is short a delivery option. (There are actually several delivery options, the value of all of which is positively affected by interest-rate volatility. The seller has the option to deliver one of a basket of cash securities to the buyer. Therefore, the futures buyer is short interest-rate volatility, as is the MBS buyer. A combination of swaps and swaptions would benefit from the correlation of swaps with MBS, as well as the exposure to interest-rate volatility.

TABLE 4
Index Replication Results (August 2002-September 2004, bp per Month)

| | | Tracking | |
|---|---|---|---|
| | Mean Out- | Error | |
| Replication Method | performance | Volatility | R² |
| a. U.S. Treasury Index Replication | | | |
| Treasury Futures | 4.5 | 10.4 | 0.997 |
| b. U.S. MBS Index Replication | | | |
| Treasury Futures | 1.2 | 35.3 | 0.811 |
| Interest-Rate Swaps | −1.8 | 38.5 | 0.775 |
| TBAs | 0.3 | 4.3 | 0.997 |
| c. U.S. Credit Index Replication | | | |
| Treasury Futures | −25.1 | 62.7 | 0.878 |
| Interest-rate Swaps | −26.9 | 57.8 | 0.896 |
| Interest-rate Swaps + CDX | 2.5 | 29.1 | 0.974 |
| d. U.S. Aggregate Index Replication | | | |
| Treasury Futures | −5.2 | 22.7 | 0.972 |
| Interest-Rate Swaps | −7.4 | 17.5 | 0.983 |
| Futures + Swaps | −7.1 | 17.3 | 0.983 |
| Futures + Swaps + TBAs | −6.1 | 16.9 | 0.984 |
| Futures + Swaps + CDX | 0.7 | 10.9 | 0.994 |
| Futures + Swaps + TBAs + CDX | 1.6 | 9.4 | 0.995 |

Interest-rate swaps improve upon the replication of the Credit Index with futures given the credit exposure embedded in interest-rate swaps. FIG. 2 shows that swap spreads have been relatively stable during a period of volatility in credit spreads. The sharp contraction in credit spreads caused futures and swaps replications to under-perform the Credit Index significantly, in return terms. While swap spreads and credit spreads were relatively stable following the fourth quarter of 2003, the period prior to that was far from stable.

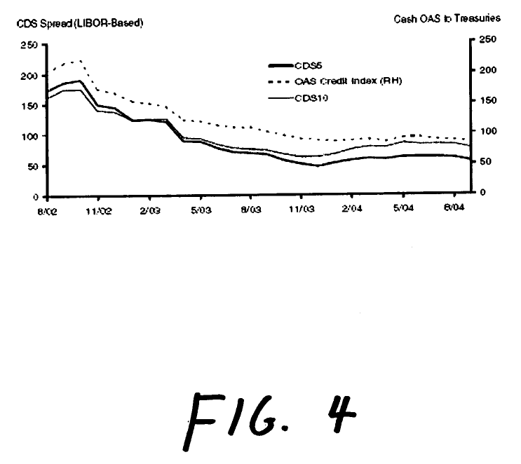

The use of CDX in the replication improves upon the replication with swaps alone. As FIG. 4 shows, CDS spreads tracked credit spreads closely over this period. Also, the relative advantage of CDS, compared to swaps alone, was much greater during the earlier period of volatility.

Table 5 demonstrates that the tracking error of the swaps-only strategy was more than twice as large that of the swaps+CDS strategy during the period of greater spread volatility. An additional benefit of CDS is the greater carry earned by the portfolio. In return for accepting default risk (which is reflected also in the credit index), the investor earns that incremental carry. As long as CDS spreads are sufficient to offset default losses, CDS will increase expected return and reduce risk.

Bringing together all of the various replication strategies listed in section (d) of Table 4, one can see how the tracking error of the Aggregate Index improves as more replicating instruments are added. The most notable improvement is adding CDS, which reduced the volatility by 6.5-8.0 bp. While TBAs are greatly superior to other methods in replicating the MBS Index by itself (4.1 bp TEV versus 36 bp for replication with futures), TBAs do not greatly improve the replication of the Aggregate Index. Table 6 gives us some insight into this.

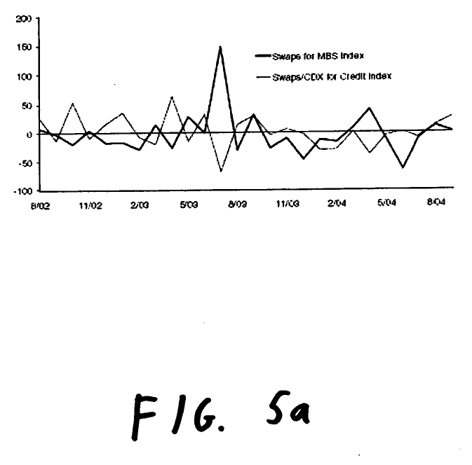

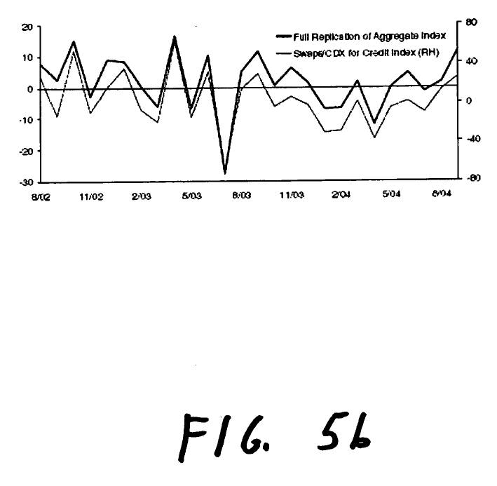

Comparing the first two lines in the correlation matrix shows a substantial negative correlation between the MBS replication with swaps and the treasury replication with futures. There is a smaller, positive correlation between the MBS replication with TBAs and the futures replication. This reflects the volatility effect highlighted above. In an environment of rising interest-rate volatility, futures would be expected to underperform cash treasuries, and swaps would outperform MBS (strong negative correlation). In that same environment, TBAs would tend to underperform the MBS Index (weak positive correlation) as TBAs tend to have higher volatility exposures than the more seasoned issues in the index. The correlation of the credit replication strategy with the two MBS replication strategies is also notably different. Rising interest-rate volatility causes swaps to outperform MBS, while convexity-hedging caused them to underperform credit, demonstrating a negative correlation between the MBS-with-swaps replication and the Credit-with-swaps replication. An example of this can be seen in FIG. 5, which plots the return difference to benchmark of various replication strategies. In July 2003, the Aggregate Index fell by 3.36%, as yields rose 94 bp. Swap spreads widened, causing swaps to underperform duration-matched Treasuries, though they outperformed MBS. Replicating portfolios for both the credit index and the Aggregate index using swaps substantially underperformed, and so we see a negative correlation between these replication strategies, and the MBS replication-with-swaps strategy. During this same month, the TBA replication strategy also underperformed, a positive correlation with the non-MBS replication strategies. Therefore, a swaps replication strategy for MBS, while notably inferior for replicating mortgages in isolation, is little different from TBA replication as part of an Aggregate Index replication strategy.

FIG. 5b demonstrates that the return differential of the full Aggregate replication strategy is driven by the the performance of the Credit Index replication. Indeed, 91% of the volatility of the Aggregate replication strategy over this period can be explained by the Credit Index replication (as measured by r-squared).

TABLE 5
Credit Replication Tracking Error (bp per month)
in Two Different Sub-Periods

| | 8/02-9/03 | 10/03-9/04 | Total Period |
|---|---|---|---|
| Swaps only | 75.9 | 22.6 | 57.8 |
| Swaps + CDS | 34.7 | 19.0 | 29.1 |

TABLE 6
Correlations of Realized Return Differentials of Replicating Strategies

| | Swaps for | TBAs for | | Swaps for |
|---|---|---|---|---|
| Correlation | MBS | MBS | Futures for UST | Credit |
| Swaps for MBS | 1.000 | −0.533 | −0.732 | −0.268 |
| TBAs for MBS | −0.533 | 1.000 | 0.343 | 0.156 |
| Futures for UST | −0.732 | 0.343 | 1.000 | 0.364 |
| Swaps for Credit | −0.268 | 0.156 | 0.364 | 1.000 |

The replication “errors” of various strategies can be explained in some cases by the presence of a risk factor in the index, exposure to which cannot be reflected in the replicating portfolio. For example, the futures replication of the Aggregate Index attempts to replicate its term structure exposure, but cannot replicate its credit exposure. Not surprisingly, as Table 7 shows, the realized return differential of the futures portfolio to the Aggregate index is highly correlated with changes in credit spreads. On the other hand, the return differential of the “full replication” strategy is not correlated with credit spreads.

These findings have important implications for the choice of replication strategy. Considered in isolation and given investor risk preferences, the choice of strategy may be clear. However, if this replication strategy is part of a larger portfolio, the relationship between the return difference of a given replication strategy and the returns of other portfolio assets must be considered. For example, an investor with sizeable equity exposure may prefer a fixed-income replication strategy using only futures, given the negative correlation with equity returns shown in Table 7. Falling equity prices have been correlated with rising credit spreads and, therefore, with excess returns to a credit replication strategy with bond futures (and swaps).

TABLE 7
Correlations of Selected Aggregate Replication Strategies
with Credit Spreads and Equities

| | Futures Replication | “Full” Replication* |
|---|---|---|
| Correl. w −ve change in | −0.847 | 0.065 |
| OAS Credit Index | | |
| Correl. w change in S&P | −0.505 | 0.047 |
| 500 Index | | |

*Replication with Futures, Swaps, TBAs, and CDX

Using a Risk Model to Forecast Replication Risk

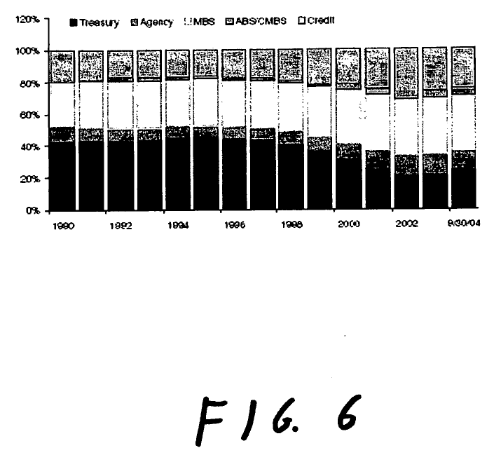

While an empirical analysis is valuable in forecasting the likely tracking errors of various replication strategies, there are some drawbacks to this approach. Most important, the weightings and characteristics of the sectors within the Lehman Aggregate index change over time, and this will affect the relative success of each index replication strategy. FIG. 6 shows that the sectoral distribution of the Aggregate Index has changed markedly over time. Credit spreads are the dominant source of risk in replication strategies. Accordingly, one would expect that replication performance would change depending on the weight of credit instruments in the Aggregate. There may, therefore, be some bias introduced into forecasts of Aggregate replication TEVs, by differences in the characteristics of the index over time. The use of a risk model can eliminate such biases.

The Lehman Global Risk Model forecasts the volatility of the return difference (TEV) between a portfolio and its benchmark. The TEV uses the current index weights and the current relative exposures between portfolio and benchmark (e.g., key-rate durations) and the historic volatilities and correlations of risk factors (e.g., yield changes). Therefore, the Risk Model approach generates a TEV forecast that is independent of changes in index characteristics over time.

Table 8 shows three replicating portfolios created to track the Lehman Aggregate for August 2004, using only Treasury futures, futures, and swaps, and a combination of futures, swaps, and TBAs. In each case, the forecast TEV is within 1-2 bp of the empirically achieved result. The risk model covariance matrix is constructed from many months of data, which greatly increases the confidence in the forecast TEV suggested by these empirical results, accumulated over 25 monthly observations.

TABLE 8
Sources of Risk (Factor Volatilities) in the Lehman
Aggregate and Replicating Strategies-Exponentially
Weighted Co-variance Matrix

| | | | | Futures + |
|---|---|---|---|---|
| | Lehman | Treasury | Futures + | Swaps + |
| Global Risk Factor | Aggregate | Futures | Swaps | TBAs |
| Yield Curve | 150.0 | 3.2 | 6.0 | 2.7 |
| Swap Spreads | 19.7 | 19.7 | 1.8 | 0.8 |
| Volatility | 7.3 | 7.3 | 7.3 | 0.4 |
| Investment-Grade | 19.0 | 19.0 | 19.0 | 16.5 |
| Spreads | | | | |
| Treasury Spreads | 0.8 | 0.8 | 0.8 | 0.8 |
| Credit and Agency | 15.8 | 15.8 | 15.8 | 15.8 |
| Spreads | | | | |
| MBS/Securitized | 7.8 | 7.8 | 7.8 | 0.9 |
| CMBS/ABS | 0.9 | 0.9 | 0.9 | 0.9 |
| Systematic risk | 146.8 | 23.1 | 19.3 | 16.0 |
| Idiosyncratic risk | 2.7 | 6.4 | 3.1 | 3.3 |
| Total risk (bp per month) | 146.8 | 24.0 | 19.6 | 16.3 |
| Empirically derived risk | N/A | 22.7 | 17.3 | 16.9 |

The risk model output also provides insight into the risks that are reduced through various replication strategies, as well as quantifying the exposures and risk factor volatilities that remain. Table 8 illustrates the importance of yield curve risk as part of the overall volatility of the Lehman Aggregate. Each replication strategy largely eliminates this source of risk, leaving other risk exposures. The risk of the futures replication strategy is not surprisingly dominated by credit and agency spread risk, while MBS spread risk and volatility risk (which largely reflects the optionality of MBS) also are significant. Using futures introduces idiosyncratic risk, reflecting the basis risk between cash and futures instruments. Spread risk factors are expressed relative to swaps, with the exception of Treasuries. Therefore, replicating credit or MBS using swaps reduces the forecast TEV attributable to swaps spreads, but leaves the TEV attributable to credit and MBS spreads unchanged.

The risk model forecasts a reduction in TEV of 3.3 bp by using TBAs to replicate the MBS portion of the Aggregate, compared to using swaps. Empirical analysis showed only a reduction of 0.4 bp, however. This demonstrates the closer correlation between swaps and MBS during the past two years, than over longer periods during which the risk model was calibrated. This increased correlation caused swaps to perform almost as well as TBAs over the period of the empirical study. Using both empirical analysis and a risk model to forecast replication tracking errors allows investors to view the effect of changes in correlations between instruments. Using an exponentially weighted, or a simple-weighted covariance matrix for ex-ante tracking errors can also allow for the impact of changing correlations on TEV.

The replication with futures, swaps, and TBAs is dominated by credit spread risk. Therefore, using CDS improves the replication, as the empirical results show.

Replication Details

A sample U.S. Aggregate replication portfolio is provided in Appendix IV, for a portfolio of notional size US $1 billion as at Jul. 31, 2004.

Rebalancing, Re-investment, and Transaction Costs

In the empirical studies, all positions are assumed to be rebalanced monthly. In practice, most investors will make small adjustments monthly to positions to allow for the changing characteristics of the index and the aging of derivative positions. On a quarterly basis, futures will be rolled to prevent the exercise of the delivery option and swaps will be rolled into the “on-the-run” maturities. TBAs are rolled monthly to avoid pool delivery. New CDX instruments are created semi-annually, and it may be assumed that a roll into the new instrument is executed with that same frequency.

During the period between the creation of new CDX instruments, it is possible that an issuer will be downgraded, causing it to fall out of the Credit Index (but remain in CDX). During this period, the investor may be subject to tracking error, as the performance of the “fallen angel” may not match that of the investment-grade credits. Based on an analysis of the historic performance of fallen angels, in the months following a fall below investment grade and the credit ratings of CDX, this risk is estimated to be 7 bp per month for the credit index. (We discuss the performance of fallen angels and distressed bonds in Portfolio and Index Strategies During Stressful Credit Markets, January 2004.) However, this risk can largely be eliminated if the investor buys single-name default protection for the downgraded issuer.

An all-derivatives portfolio, by definition, does not require cash, outside of that needed to meet variation margin for futures or mark-to-market collateral calls for swaps. Cash is assumed to be invested in 1-month LIBOR. In practice, investors will be required to deposit initial margin with the clearing firm (current CBOT initial margin requirements for 2-year, 5-year, 10-year, and long bond futures are $743, $810, $1,350, and $2,025 per contract, respectively), which, for an Aggregate Index replicating portfolio, currently averages 1.3% of the notional portfolio amount. However, both this and any variation margin can be posted in the form of T-bills. As a result, only a small portion of funds will be invested below LIBOR in practice.

Transaction costs will depend upon the choice of strategy and the frequency of rebalancing. Table 9 displays estimated transaction costs, assuming monthly rebalancing.

TABLE 9
Transaction Costs of Various Replication Strategies

| Replication Strategy | Cost (bp per month) |
|---|---|
| Futures | 0.5 |
| Swaps | 0.3 |
| Futures + Swaps | 0.3 |
| Futures + Swaps + TBAs | 0.9 |
| Futures + Swaps + TBAs + CDX | 1.0 |

Replicating the Global Aggregate (or Just the U.S. Portion)

Using a combination of strategies can achieve the lowest tracking error for replicating the U.S. Aggregate Index. Whether this also holds true for the Global Aggregate depends upon the choices of strategies in the various currency “blocks,” and whether these are active or passive replication strategies.

Table 10 suggests that the choice of replicating strategy in the U.S. may be correlated with the strategy used for managing the Euro Aggregate component (of the Global Aggregate). In Table 10, the correlations between the return differences of two replicating strategies (versus benchmark) and returns on Euro credit (excess return) and Euro governments (price return) are shown. The return differences of the futures replication strategy turn out to be strongly negatively correlated with excess return to Euro credit. This is not surprising, since the risk from a futures-only replication strategy of the U.S. Aggregate is largely coming from credit (see Table 8); the short U.S. credit exposure is negatively correlated with long Euro credit. This may be attractive for an active European-based investor if the value-added generated is positively correlated with European credit excess returns (and therefore negatively correlated with the U.S. replication strategy). However, for many investors, a low correlation will be preferred, since the overall risk of the portfolio will be reduced, whether the investor is short or long Euro credit.

There is a modest improvement in tracking error contributed by replicating the U.S. MBS index with TBAs. This improvement would be reduced further in a Global Aggregate-benchmarked portfolio, since the weighting of the MBS index is much smaller, and the higher tracking error associated with replicating the index with swaps is diversified away.

Different replicating strategies for the non-U.S. portions of the Global Aggregate will have different correlations with the U.S. replication. Table 10 suggests that if Futures replication is used for the U.S. portion, there will be a significant positive correlation with a Euro replication strategy that is effectively short Euro credit (e.g., a Euro-futures replication strategy). Fortunately, there are replication strategies that a Global Aggregate manager can use to replicate the Euro-Aggregate that mirror the techniques discussed herein for replicating the U.S. Aggregate. In particular, portfolio CDS products such as iTRAXX can be used, together with interest-rate swaps, to replicate the Euro-credit index. It is believed that the use of iTRAXX, together with a portfolio of interest rate swaps, can reduce the tracking error associated with replicating the Euro-credit index.

TABLE 10
Aggregate Replication Error (bp per month)
in Two Different Sub-periods

| | Futures | Full |
|---|---|---|
| | Replication | Replication |
| Correlation with Euro Credit Excess Return | −0.69 | −0.02 |
| Correlation with Euro Government Price | 0.07 | 0.29 |
| Return | | |

Choices

There are various considerations in choosing the appropriate replication strategy. Portfolio constraints may ultimately determine the choice of strategy, perhaps restricting the investor to a futures-only strategy or a combination not considered herein (e.g., futures+TBAS). In the absence of client constraints, the investor's risk “utility function” (i.e., cost per unit of risk reduction) will determine the choice of strategy. If the degree of risk aversion is high, a total return swap may prove to be a desirable choice. However, for large replicating portfolios (e.g., above $300 million), sufficient liquidity may not exist to permit the use of an index swap for the entire portfolio.

The choice of replication method should not be considered in isolation but rather in combination with the overall strategy. It is not necessarily the case that the lowest TEV strategy is always preferable. For example, if the replication is part of a portable alpha strategy, the relationship of the expected return deviations from benchmark of various replication strategies should be considered relative to the expected alpha of the strategy. A replication strategy for the Aggregate Index using treasury futures will outperform during times of widening spreads and underperform in the opposite environment. The correlation of this performance pattern to the alpha strategy may actually make this a more attractive option than a replication strategy that, by itself, has a lower tracking error. The choice of replication strategy to be used for the MBS Index will depend upon whether the entire Aggregate index is being replicated or just the mortgage component.

Other Embodiments

At least one embodiment of the present invention comprises a computer-implemented method for creating a total return swap on a Replicating Bond Index (RBI) basket (for example, a total return swap on the Lehman Brothers U.S. Aggregate RBI basket). While one embodiment may be used to create RBI baskets for the U.S. Aggregate, and the U.S. Credit index, other embodiments, apparent to those skilled in the art, can be used to create RBI baskets for the Lehman Global Aggregate (of which the U.S. Aggregate and Credit Indices are subsets). There are several innovations related to this method. For example:

1. The creation of a total return swap on a basket of instruments that replicates a bond index (there have been total return swaps on bond indices, but not on replicating portfolios).

2. The creation of options on a basket of instruments that replicates a bond index.

3. The creation of a structured note, the payment on which is linked to the return of an RBI basket.

4. The creation of a structured note or Special Purpose Vehicle that combines an RBI basket with an “alpha” source, such as a Hedge Fund of Funds

5. The process of constructing the RBI basket.

6. The use of Lehman Swap Indices, (or equivalents thereof) in a replicating basket.

4. The use of Lehman fixed income indices in a replicating basket.

In one embodiment, a legal agreement for the transaction comprises a standard total return swap term sheet (Party A pays LIBOR+X b.p., Party B pays the return on RBI basket), and a “fact sheet” that describes the construction of the RBI basket. An exemplary preferred fact sheet is provided below.

Factsheet:

The Lehman U.S. Aggregate Index (“Aggregate Index”) contains U.S. dollar denominated securities that qualify under the index's rules for inclusion, which is based on the currency of the issue. The principal asset classes in the index are Government, Credit and Securitized bonds. The Aggregate Index was launched on Jan. 1, 1976

The Replicating Bond Index (RBI) basket is an index designed to track the return of the Aggregate Index. Series 1 uses a combination of liquid instruments and Lehman sub-indices to track the Aggregate Index.

RBI Basket Construction: The components of the RBI basket will be adjusted monthly in order that the weightings to each index or instrument match the published weightings of the Aggregate Index. In Series 1, the sectors within the Aggregate Index will be matched as shown in Table 11.

TABLE 11

| Sector | Index/Instrument |
|---|---|
| Treasury | Lehman U.S. Treasury Index |
| Mortgage | Lehman U.S. MBS Index |
| Credit | Lehman Mirror Swap U.S. Credit Index + CDX..N.A.IG |
| | 5 yr and 10 yr |
| Agency | Lehman Mirror Swap U.S. Agency Index |
| ABS | Lehman Mirror Swap U.S. ABS Index |
| CMBS | Lehman Mirror Swap U.S. CMBS Index |

Lehman Mirror Swap indices provide published total returns of a portfolio of interest-rate swaps constructed to match the key-rate durations of major Lehman bond indices. The Lehman Brothers U.S. Credit Index (“Credit Index”) is replicated using a combination of the Mirror Swap Credit Index and the most current investment grade CDX instruments with 5 and 10 year maturities. The allocations to CDX are computed in order that the weighted average Spread DV01, will be the Spread DV01 of the Credit Index and the weighted average spread to LIBOR of CDX will equal the differential between the Option-Adjusted Spread (OAS) on the Credit Index and the OAS on the Mirror Swap Credit Index, values as reported on LehmanLive.

TABLE 12
Pricing and Related Issues

| Issue | Index/Instrument |
|---|---|
| Pricing Frequency | Daily on T + 1 basis |
| Timing of pricing | 3:00 pm New York time |
| Bid or Offer | Outstanding issues are priced on bid side. |
| | New issues enter on the offer side |
| Sources | Lehman trading desks |
| Verification | All prices are checked against a blend of multiple |
| | contributors by our quality control group. Variations |
| | are analyzed and corrected if necessary |
| Reinvestmen of | Index cashflows are reinvested at the start of |
| cashflows | the month following their receipt |
| Interest on cash | Mirror Swap indices assume that cash is |
| | invested at 3 mth LIBOR |

End of Factsheet

Reference 3, cited below, discusses replication of the Global Aggregate index. That paper describes a number of different approaches to replicating bond indices. Embodiments of the subject invention comprise at least two new innovations to these approaches to replication. The first innovation, described below, provides an improved approach for matching the interest-rate sensitivity of a given index. Previous approaches split the index into duration “buckets” (e.g., 0-3 year duration, 3-5 year, etc.), and matched the interest-rate sensitivity of one future to one bucket. At least one embodiment of the present invention comprises matching the full duration profile of the index, using a Key-rate duration approach. A further embodiment of the present invention comprises utilizing total return swaps on certain components of a bond index in addition to swaps on baskets or replicating instruments in order to replicate a broad index.

Applications

Applications of RBI baskets include the following:

As the beta component in a portable alpha strategy

To express an investment view by creating or eliminating broad exposure to a market index

In management of portfolio cash inflows and outflows

To preserve market exposure during the course of an asset re-allocation.

To hedge the market exposure of variable annuity providers

To create enhanced index products, for example, by combining an RBI basket with a portfolio of floating-rate assets.

Replicating Index Returns with Treasury Futures: Duration Cells versus Key-Rate Durations

Since the rediscovery of duration in the late 1970s, investors have been looking for better ways to measure interest-rate sensitivity. Duration proved to be a useful measure of price sensitivity to parallel shifts in the yield curve, though managers recognized that for nonparallel shifts, additional information was needed to gauge interest-rate risk properly. Many managers sliced their portfolios and indices into maturity buckets and used duration distribution across these buckets. As managers switched from government/credit benchmarks to aggregate benchmarks, with a high percentage of callable securities, duration buckets replaced maturity buckets.

In recent years, partial durations have become increasingly popular as a measure of yield curve sensitivity. Instead of a single duration number, a vector of partial durations describes the sensitivity to yield curve twists. The sensitivity of a given bond to a non-parallel yield curve movement is a function of the distribution of its cash flows. If a portfolio is constructed from bullet bonds, the present values of whose cash flows are largely distributed within a narrow maturity “window” (e.g., bullet securities), duration bucketing should give a reasonable view of yield curve risk. However, where the present value contributions from bonds' cash flows are distributed more evenly across the curve (e.g., amortizing securities such as MBS), duration bucketing is likely to be less satisfactory.

KRD is related to partial duration. Certain points on the par curve are selected as key rates. For maturities between the key rates, it is assumed that rates move according to linear interpolation. For example, in Lehman's model, six key rates are used—6 month, 2-year, 5-year, 10-year, 20-year, and 30-year. A 5-year KR shift assumes no shift in the 2- or 10-year rate, and interpolated shifts between the 5- and 2-year and the 5- and 10-year, a so-called tent shift. The 5-year KRD of any bond is then the sensitivity of the bond price to a 100 bp shift in the 5-year key rate with an appropriate tent shift in the term structure between two and ten years.

The durations and key-rate durations (KRD) of a Treasury security and an MBS security are shown in Table 13. Both securities have near-identical option-adjusted durations (OAD), but very different interest rate profiles. Accordingly, a long position in one security, offset by a short position in the other, will be sensitive to non-parallel interest-rate movements. The Lehman Brothers global risk model can quantify the yield curve risk arising from this KRD mismatch. (Risk is a function of the exposure (the key rate duration mismatch) and the historical volatility of that exposure.) Examining just the term structure risk due to the KRD mismatch (excluding risk due to convexity or sector mismatches), this is found to be 7.8 bp of return volatility per month.

TABLE 13
Option-Adjusted Duration and Key-Rate Durations of U.S. Treasury and
Mortgage Security

| | | Key Rate Duration | | | | | |
|---|---|---|---|---|---|---|---|
| | OAD | 6-Mo | 2-Yr | 5-Yr | 10-Yr | 20-Yr | 30-Yr |
| UST 6.5% 2/10 | 4.74 | 0.02 | 0.10 | 4.05 | 0.57 | 0.00 | 0.00 |
| FNMA 5.5% 2003 | 4.73 | 0.15 | 0.57 | 0.99 | 1.77 | 1.15 | 0.11 |

It is often argued that duration bucketing should provide a reasonable picture of interest rate exposure for diversified portfolios and indices. The reasoning is that while some securities may indeed be placed into duration buckets that do not reflect their true interest-rate sensitivities, perhaps these errors are reduced in large portfolios. To examine this assertion, in Table 14 the duration profiles of the Lehman Brothers Intermediate Treasury Index and the U.S. MBS Index are compared.

TABLE 14
Comparative Duration Exposures for the Intermediate Treasury
and Mortgage Indices, as of May 31, 2004

| | Duration | | | | | |
|---|---|---|---|---|---|---|
| | | | | 6-8 | 8-10 | 10+ |
| | 0-2 Yr | 2-4 Yr | 4-6 Yr | Yr | Yr | Yr |
| Market Value (%) | | | | | | |
| Intermediate Treasury | 35.07 | 29.13 | 19.84 | 12.94 | 0.00 | 0.00 |
| MBS | 5.30 | 40.04 | 50.60 | 4.07 | 0.00 | 0.00 |
| OAD Contributions | | | | | | |
| Intermediate Treasury | 0.54 | 0.86 | 0.90 | 0.93 | 0.00 | 0.00 |
| MBS | 0.09 | 1.28 | 2.52 | 0.26 | 0.00 | 0.00 |
| Key-Rate Durations | 6-Mo | 2-Yr | 5-Yr | 10-Yr | 20-Yr | 30-Yr |
| Intermediate Treasury | 0.14 | 0.96 | 1.37 | 0.98 | 0.00 | 0.00 |
| MBS | 0.16 | 0.56 | 1.02 | 1.53 | 0.78 | 0.09 |

A comparison of the duration contributions with the KRDs shows that for bullet bonds, duration bucketing provides a reasonable view of yield curve exposure. For the Intermediate Treasury Index, the buckets' duration contributions provide a view of yield curve exposure not too different from the KRD profile. However, for the MBS Index, duration buckets present a somewhat misleading picture. If the Treasury Index is viewed as a portfolio and the MBS Index as its benchmark, a duration-bucketing view would suggest that the portfolio has a large yield-curve mismatch compared with the index. In particular, the portfolio would seem to have a substantial underweight in the 4- to 6-year duration bucket, almost fully offset by an overweight in the 6- to 8-year duration bucket. Accordingly, a hypothetical portfolio manager might conclude that the portfolio was exposed to yield curve flattening and choose to reduce risk by increasing exposure to the 6- to 8-year bucket. However, the KRD exposures tell a very different story. The portfolio is overweighted to 5- and 10-year yield curve points and underweighted to the 20-year point. Therefore, a hypothetical manager is actually exposed to a yield-curve steepening.

As an exercise, the return effect of a particular yield curve shift is examined. In Table 15, instantaneous shifts of plus and minus 25 bp are applied to the 5-year key rate and every security in each index is revalued. By the definition of key-rate shifts, the move in the 5-year will not affect the par rates shorter than two and longer than ten years, but will affect intervening maturities at a declining linear rate.

Table 15 shows that the Treasury Index is more sensitive to a shift in the 5-year rate than the MBS Index. This is consistent with the sensitivities indicated by the KRD profile in Table 14, but is not consistent at all with the duration bucketing pattern.

TABLE 15
Projected Total Returns under Instantaneous Yield Curve
Shifts Total Return (bp) under Scenario

| | 5-Year KR | 5-Yr KR |
|---|---|---|
| Index | Down 25 bp | Up 25 bp |
| Intermediate Treasury | 34.6 | −34.3 |
| MBS | 26.8 | −30.1 |

Empirical test is perhaps the most effective way of gauging whether KRDs are indeed superior as a measure of yield curve exposure. In particular, one can test whether a strategy that seeks to replicate a given index by matching KRDs is superior (i.e., results in a lower tracking error) to one that matches the index by duration bucketing.

In a series of studies dating back to 1997, techniques for replicating returns of popular Lehman Brothers indices with baskets of Treasury futures were developed. These techniques are popular with asset managers engaged in portable alpha strategies or in active tactical asset allocation. See Replicating Index Returns with Treasury Futures, Lehman Brothers, November 1997; Replication with Derivatives—The Global Aggregate Index and the Japanese Aggregate Index, Lehman Brothers, March 2001; “Hedging and Replication of Fixed-Income Portfolios,” Dynkin, Hyman, and Lindner, The Journal of Fixed Income, March 2002. As part of these studies, the tracking errors associated with replicating various indices were examined using a duration-bucketing approach. Typically, the relevant index is divided into four duration cells: 0-3 year, 3-5 year, 5-7.5 year, and 7.5 years and higher, with the exception of mortgages. (For the MBS Index, given the lack of long-duration securities, we eliminate the 7.5+duration bucket so that the third bucket becomes 5+year duration, which is replicated with 10-year note futures contracts.) For a given target portfolio size, the number of 2-year, 5-year, 10-year, and long bond futures contracts required to match the dollar duration of each cell is calculated. At the end of each month, this calculation is performed on the forward-looking (“statistics”) universe of the index, and the numbers of futures contracts are adjusted as appropriate. Once a quarter, the contracts are rolled to avoid the possibility of the exercise of the delivery option.

As discussed above, an alternative to the duration bucketing approach is KRD-matching, which minimizes the differences between the KRD profiles of a given index and the replicating futures position. Because there are six KRDs in Lehman's term structure model and only four futures contracts, it is not possible to achieve a perfect match. Therefore, an optimization that minimizes the sum of the squared differences between the respective index and replicating portfolio KRDs is set up, subject to the constraint that the sum of the KRDs must be identical. The cash is assumed to be invested in 1-month LIBOR.

Table 16 shows the results of replications of the U.S. Treasury Index, the MBS Index, and the Credit Index, using the duration bucketing approach and the KRD-matching approach.

TABLE 16
Comparison of the KRD Replication Approach with Duration Bucketing,
Monthly Rebalancing, June 2000-April 2004

| | Monthly Tracking Error Volatility (bp) | | | |
|---|---|---|---|---|
| Index | Duration Buckets | KRD Matching | Difference | Percent |
| Treasury | 10.7 | 8.6 | −2.1 | −19.10 |
| MBS | 38.3 | 36.9 | −1.4 | −3.60 |
| Credit | 87.9 | 86.7 | −1.2 | −1.40 |

The KRD-matching approach does improve tracking in the replication of all three indices. The biggest improvement, in both absolute and percentage terms, is achieved in replicating the Treasury Index. This is not entirely unexpected, since yield curve exposure is the only important source of risk, where the advantage of KRD matching matters most. On the other hand, the Credit Index shows the smallest improvement because of the magnitude of other risk exposures.

A replication strategy using duration buckets was developed in 1997. In mid-2000, key-rate durations for U.S. fixed income securities and for bond futures were generated. Recent analysis suggests that using key-rate durations to replicate indices leads to a small improvement in the performance of replication strategies using futures.

The second innovation, described above, combines separate replication instruments previously used separately, and also uses a relatively new instrument (CDX).

Mirror swap indices were first created by Lehman Brothers in 2002 and use a key-rate duration approach to match the term structure exposure of a given index with a portfolio of interest-rate swaps. See reference 8, cited below. In at least one embodiment of the present invention, in constructing an RBI basket, use is made of a number of different techniques outlined herein, to replicate sub-sectors of various indices. Additionally, in the case of certain subsectors, the RBI basket may include the index itself (e.g., the U.S. treasury index).

### BIBLIOGRAPHY OF RELEVANT PUBLICATIONS

1. Replicating Index Returns with Treasury Futures, November 1997
2. The Global Aggregate: Return Replication with Derivatives, September 2000
3. Replication with Derivatives: The Global Aggregate Index and the Japanese Aggregate Index, March 2001
4. Tradable Proxy Portfolios for the Lehman Brothers MBS Index, July 2001
5. The Replication of the Lehman Global Aggregate Index with Cash Instruments, August 2001
6. L. Dynkin, J. Hyman, and P. Lindner (2002), Hedging and Replication of Fixed-Income Portfolios, The Journal of Fixed Income, March, pp. 43-63.
7. Replicating Index Returns with Treasury Futures: Duration Cells versus Key-rate Durations, July 2004
8. The Lehman Brothers Swap Indices, January 2002
9. Swaps as a Total Return Investment, April 2003
10. Simulating Portable Credit Strategies with CDS and Mirror Swap Indices, October 2003
11. Credit Derivatives Explained, March 2001
12. Replicating the Lehman Global Aggregate Index with Liquid Instruments, August 2005
13. A Guide to the Lehman Brothers Global Family of Indices, March 2006

All publications referenced above may be accessed from the Quantitative Portfolio Strategy site under Global Strategy on LehmanLive (live.lehman.com), except 10-11 (Lehman Quantitative Credit Research). Also, 3 is included in provisional application No. 60/674,358 as Appendix C; 6 is included as Appendix B; and 8 is included as Appendix F.

### Appendix I the Lehman U.S. Aggregate Index

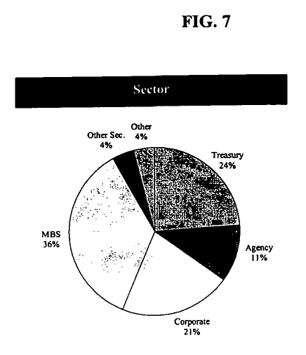

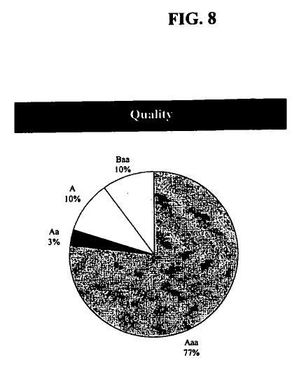

The U.S. Aggregate Index contains U.S. dollar-denominated securities that qualify under the index's rules for inclusion. See FIGS. 7 and 8, and Tables 17-20 below. Inclusion is based on the currency of the issue, and not the domicile of the issuer. The principal asset classes in the index are Government, Credit (including corporate issues), and Securitised bonds. Securities in the index roll up to the US Universal and Global Aggregate Indices. The U.S. Aggregate Index was launched on Jan. 1, 1976.

TABLE 17
Access to the Index

| | |
|---|---|
| Index Client Website | Index and constituent-level data |
| www.lehmanlive.com | Performance time series |
| | Index turnover reports |
| KEY FEATURES | Fully customisable views |
| | Standardised market structure reports |
| | Guides to indices and |
| | portfolio strategies |
| Bloomberg Page LEHM | Total Return Index |
| | Value: LBUSTRUU |
| | Market Value: LBUSMVU |
| Tickers for Key Data Series | Yield to Worst: LBUSYW |
| | Mod. Adj. Dur. (Returns Universe): |
| | LBUSRMD |
| | Average OAS: LBUSOAS |
| | Maturity: LBUSMAT |
| POINT (Portfolio and Index Tool) | Performance attribution |
| Accessible for selected clients via | Market structure reports |
| www.lehmanlive.com | Index constituents |
| | Portfolio upload/analysis |
| KEY FEATURES | Multi-factor global risk model |
| | Tracking error optimiser |
| | Automated batch processing |
| | Fully customisable |

TABLE 18
Pricing and Related Issues

| | |
|---|---|
| Frequency | Daily, on a T + 1 basis. If the last business day of the |
| | month is a holiday in the U.S. market, |
| | then prices from the previous business day are used. |
| Timing | 3:00 pm New York time. |
| Bid or Offer Side | Outstanding issues are priced on the bid side. |
| | New issues enter the index on the offer side. |
| Sources | Lehman trading desks. |
| Methodology | Multi-contributor verifications: The Lehman price for |
| | each security is checked against a blend of alternative |
| | valuations by our quality control group. Variations |
| | are analyzed and corrected, as necessary. |
| Reinvestment of | Index cashflows are reinvested at the start of the month |
| Cashflows | following their receipt. There is no return on |
| | cash held intra-month. |

TABLE 19
Rules for Inclusion

| Amount Outstanding | $250 million as of Jul. 1, 2004 | |
|---|---|---|
| Quality | A minimum bond level rating of Baa3 from Moody's Investors Service or BBB- | |
| | from Standard & Poor's Ratings Group. | |
| | The lower of the two agencies' ratings applied for qualification purposes | |
| | Where a rating from only one agency is available, that rating is used to | |
| | determine the bond's index rating | |
| | Unrated securities are included if an issuer rating is applicable | |
| | Unrated subordinated securities are included if a subordinated issuer rating is | |
| | applicable | |
| Maturity | One year minimum to final maturity on dated bonds, regardless of put or call | |
| | features | |
| | Undated securities are included in the index provided their coupons switch from | |
| | fixed to variable rate. These are included until one year before their first call | |
| | dates, providing they meet all other index criteria | |
| Seniority of Debt | Senior and subordinated issues are included. Undated securities are included | |
| | provided their coupons switch from fixed to variable rate. | |
| | The following types of fixed to variable-rate security structures will also qualify for | |
| | the index | |
| | If the holder has the option to force the issuer to issue preference shares post the | |
| | call date | |
| | If there are other economic incentives for the issuer to call the issue, such as the | |
| | removal of tax benefits after the first call date | |
| | Fixed rate perpetual capital securities which remain fixed rate following their first | |
| | call dates, and which provide no economic incentives to call the bonds, are excluded. | |
| Currency of Issue | US dollars | |
| Market of Issue | US public debt market | |
| Security Types | Included: | Excluded: |
| | Fixed rate bullet, puttable | Bonds with equity-type features (e.g., |
| | and callable | warrants, convertibility to equity) |
| | Soft bullets | Private placements are excluded |
| | | Floating rate issues |

TABLE 20
Rebalancing Rules

| | |
|---|---|
| Frequency | Statistic (projected) Universe: Daily. |
| | Returns Universe: Monthly, on the last business |
| | day of the month. |
| Methodology | During the month, all indicative changes to |
| | securities are reflected in both the statistics |
| | (projected) universe and returns universe on a daily basis. |
| | This would include changes to ratings, amounts |
| | outstanding, or sector. These changes affect the |
| | qualification of securities in the statistics (projected) |
| | universe on a daily basis, but only affect the qualification |
| | of bonds for the returns universe at the end of the month. |
| Timing | Qualifying securities issued, but not necessarily settled, |
| | on or before the month-end rebalancing date qualify for |
| | inclusion in the following month's returns universe. |

### Appendix II Replicating the Lehman MBS Index

Mortgage securities constitute a significant portion of the Lehman Brothers Aggregate Index and the Lehman Global Aggregate Index (35.5% and 14.2% of market value, respectively, as of Sep. 30, 2004). To track these indices, it is desirable to take exposure to the U.S. mortgage market. To some global investors, the U.S. mortgage market is enigmatic and intimidating because of its arcane terminology and highly variable cash flows. However, while achieving outperformance in this market indeed requires considerable knowledge and experience, the MBS Index is easier to track.

The Lehman MBS Index consists of tradable fixed-rate mortgage pass-through securities, and is limited to conforming pools guaranteed by the U.S. government (Ginnie Mae) or by government-sponsored enterprises (Fannie Mae and Freddie Mac). In lieu of buying a pool, an investor can buy a TBA (to-be-announced) contract that is a forward contract to buy MBS pools of a given agency/program and coupon. The specific pools that the investor is buying are unknown until two days before settlement. Because it is a forward contract, no cash outlay is required until settlement. For example, in October 2004, an investor could agree to buy a 30-year FNMA 5.5% TBA for delivery and settlement on Nov. 15, 2004. The investor could choose to take delivery of the security, or roll the TBA, by selling the same TBA prior to settlement date, and purchasing a TBA for December delivery. By purchasing a portfolio of TBAs, an investor can maintain exposure to the MBS market without ever taking delivery of any pools.

Generally, buyers and sellers of TBA contracts on current production mortgage coupons implicitly assume average attributes of the pools likely to be delivered. In other words, a TBA contract corresponds to a large pool of recently issued loans or a current production index composite. Because there is ample supply of new production to deliver against the TBA contract and little prepayment history to help identify pools with potentially highly idiosyncratic prepayment behavior, it is likely that a current coupon TBA contract will closely track the current production index composite.

TBAs offer two key advantages to investors. First, they are suitable for an all-derivative mortgage-replication strategy, since no cash outlay is required. Second, the TBA strategy greatly simplifies back-office processing because there is no physical delivery of pools, and therefore there are no monthly interest and principal payments. There also are some disadvantages. A change in the prepayment quality of TBA deliverables versus the rest of the MBS market can lead to underperformance of TBAs, even if the investor rolls their TBAs from month-to-month. Since the seller of a TBA has the option to deliver any mortgage pool, he will generally deliver the least attractive pool, which is reflected in the pricing of TBAs. The investor can also at times earn significant return from rolling TBAs due to imbalances in the current month's supply and demand for a particular mortgage coupon.

A detailed description of the construction of TBA portfolios to replicate the MBS Index is provided in the paper on “Tradable Proxy Portfolios for the Lehman MBS Index,” listed in the bibliography herein.

### Appendix III Credit Default Swaps

The primary purpose of credit derivatives is to enable the efficient transfer and repackaging of credit risk. “Credit risk” encompasses all credit related events ranging from a spread widening, through a ratings downgrade, all the way to default. In their simplest form, credit derivatives provide a more efficient way to replicate in a derivative form the credit risks that would otherwise exist in a standard cash instrument. For example, a standard credit default swap can be replicated using a cash bond and the repo market. Alternatively, a cash credit instrument can be replicated by combining a credit default swap with the fixed receipt of an interest-rate swap.

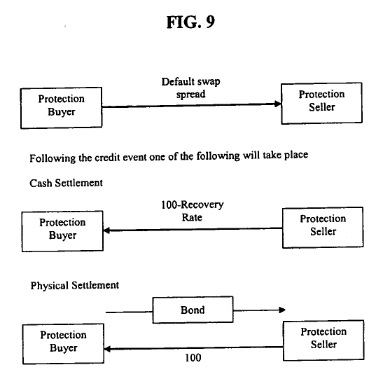

A default swap is a bilateral contract that enables an investor to buy protection against the risk of default of an asset issued by a specified reference entity. Following a defined credit event, the buyer of protection receives a payment intended to compensate against the loss on the investment. This is depicted in FIG. 9. In return, the buyer of protection pays a fee. Usually, the fee is paid over the life of the transaction in the form of a regular accruing cash flow. The contract is typically specified using the confirmation document and legal definitions produced by the International Swap and Derivatives Association (ISDA).

Some default swaps define the triggering of a credit event using a reference asset. The main purpose of the reference asset is to specify exactly the capital structure seniority of the debt that is covered. The reference asset also is important in the determination of the recovery value should the default swap be cash settled. In many cases, following a default, the protection buyer will deliver a defaulted security for which it will receive par from the protection seller. The maturity of the default swap need not be the same as the maturity of the reference asset; it is common to specify a reference asset with a longer maturity than the default swap.

CDX.NA.IG is a static portfolio of 125 equally weighted credit default swaps on 125 North American reference entities that are rated investment grade; it is available in a range of maturities. Every six months a new set of CDX instruments is created, though existing instruments will continue to trade. Like individual CDS, they are unfunded instruments. A credit event triggered by a reference asset will be settled by the physical delivery of a deliverable defaulted security in exchange for par. By combining CDX with a portfolio of interest rate swaps (receiving fixed), it is possible to replicate, in unfunded form, the exposures of a portfolio of cash credit instruments.

This appendix draws on material from the Lehman publication “Credit Derivatives Explained” (cited herein).

FIG. 9 depicts mechanics of a typical default swap. Between trade initiation and default or maturity, protection buyer makes regular payments of default swap spread to protection seller.

### Appendix IV Replicating Portfolio as at Jul. 31, 2004

TABLE 21

| | | | | |
|---|---|---|---|---|
| | Position | | | Maturity |
| Identifier | Amount | Description | Coupon | Date |

Sector Cash

| | | |
|---|---|---|
| USD | $1,000,000,000 | CASH - U.S. Dollar |

Sector: FUTURES
(4 positions)

| | | |
|---|---|---|
| TUU4:CBT | $98,800,000 | 2 year Treasury Notes |
| FVU4:CBT | −$1,800,000 | 5 year Treasury Notes |
| TYU4:CBT | $75,800,000 | 10 year Treasury Notes |
| USU4:CBT | $42,700,000 | 30 year US Treasury Bonds |

Sector: INTEREST_RATE_SWAP
(6 positions)

| | | | |
|---|---|---|---|
| IRD_9327 | $72,227,000 | IRSwap USD 1.965 LIBOR | Jan. 31, 2005 |
| | | 6M | |
| IRD_9332 | $144,781,000 | IRSwap USD 3.087 LIBOR | Jul. 31, 2006 |
| | | 2Y | |
| IRD_9335 | $135,037,000 | IRSwap USD 4.199 LIBOR | Jul. 30, 2009 |
| | | 5Y | |
| IRD_9338 | $67,731,000 | IRSwap USD 4.99 LIBOR | Jul. 30, 2014 |
| | | 10Y | |
| IRD_9341 | $21,536,000 | IRSwap USD 5.535 LIBOR | Jul. 30, 2024 |
| | | 20Y | |
| IRD_9344 | $16,971,000 | IRSwap USD 3.0 LIBOR | Jul. 30, 2034 |
| | | 30Y | |

Sector: MORTGAGES
(2 positions)

| | | | |
|---|---|---|---|
| FNC044QG | $43,608,833 | FNMA Conventional Interm. | 4.5 |
| | | 15 yr | |
| FNC050QG | $39,688,972 | FNMA Conventional Interm. | 5.0 |
| | | 15 yr | |
| FNC054QG | $13,943,931 | FNMA Conventional Interm. | 5.5 |
| | | 15 yr | |
| FNC060QG | $18,488,638 | FNMA Conventional Interm. | 6.0 |
| | | 15 yr | |
| FNA054QG | $42,630,967 | FNMA Conventional Long | 5.5 |
| | | T. 30 yr | |
| FNA060QG | $38,007,295 | FNMA Conventional Long | 6.0 |
| | | T. 30 yr | |
| FNA064QG | $54,389,948 | FNMA Conventional Long | 6.5 |
| | | T. 30 yr | |
| FGB050QG | $31,962,198 | FHLM Gold Guar Single | 5.0 |
| | | F. 30 yr | |
| FGB054QG | $27,945,910 | FHLM Gold Guar Single | 5.5 |
| | | F. 30 yr | |
| GNA064QG | $22,404,484 | GNMA ISingle Family 30 yr | 6.5 |
| GNA060QG | $13,129,784 | GNMA ISingle Family 30 yr | 6.0 |
| GNA054QG | $1,961,961 | GNMA ISingle Family 30 yr | 5.5 |
| GNA050QG | $10,934,080 | GNMA ISingle Family 30 yr | 5.0 |

Sector: CREDIT DEFAULT
SWAPS (2 positions)

| | | | |
|---|---|---|---|
| CDX.IG | $167,429,000 | CDX Investment Grade 5 yr | Sep. 20, 2009 |
| February 2009 | | #2 | |
| CDX.IG | $76,671,000 | CDX Investment Grade 10 yr | Sep. 20, 2014 |
| February 2014 | | #2 | |

Embodiments of the present invention comprise mathematical models, computer components and computer-implemented steps that will be apparent to those skilled in the art. For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, all calculations preferably are performed by one or more computers. Moreover, all notifications and other communications, as well as all data transfers, to the extent allowed by law, preferably are transmitted electronically over a computer network. Further, all data preferably is stored in one or more electronic databases.

Various embodiments described herein are not intended to be mutually exclusive; those skilled in the art will recognize that various combinations of these and other embodiments are within the scope of the invention.

While particular elements, embodiments, and applications of the present invention have been shown and described, it should be understood that the invention is not limited thereto, since modifications may be made by those skilled in the art, particularly in light of the foregoing teaching. The appended claims are intended to cover all such modifications that come within the spirit and scope of the invention.

We claim:

1. A method for replicating a first index, comprising:
constructing a basket of derivative financial instruments selected to replicate said index;
wherein said basket of derivative financial instruments is constructed using key rate duration matching based on a plurality of instruments, and
wherein said basket is reconstructed on a periodic basis approximately equal to that on which said index is reconstructed.

2. A method as in claim 1, wherein said plurality equals the number of types of duration of instruments in said index.

3. A method as in claim 1, wherein said first index is a fixed income index.

4. A method as in claim 1, wherein said derivative financial instruments comprise treasury futures.

5. A method as in claim 1, wherein said derivative financial instruments comprise interest rate swaps.

6. A method as in claim 1, wherein said derivative financial instruments comprise CDX products.

7. A method as in claim 1, wherein said derivative financial instruments comprise credit default swaps.

8. A method as in claim 1, wherein said basket comprises a second index.

9. A method as in claim 1, further comprising providing a total return swap, wherein a purchaser of said swap is guaranteed a return equivalent to that of said index.

10. A method comprising offering a total return swap for sale, wherein said total return swap is as in claim 9.

11. A method comprising offering a basket of derivative financial instruments for sale, wherein said basket of derivative financial instruments is as in claim 1.

12. A method for replicating a portfolio of securities, comprising:
constructing a basket of derivative financial instruments selected to replicate said portfolio;
wherein said basket of derivative financial instruments is constructed using key rate duration matching based on a plurality of instruments, and
wherein said basket is reconstructed on a periodic basis approximately equal to that on which said portfolio is reconstructed.

13. A method as in claim 11, wherein said plurality equals the number of types of duration of instruments in said index.

14. A method as in claim 11, wherein said first index is a fixed income index.

15. A method as in claim 11, wherein said derivative financial instruments comprise treasury futures.

16. A method as in claim 11, wherein said derivative financial instruments comprise interest rate swaps.

17. A method as in claim 11, wherein said derivative financial instruments comprise CDX products.

18. A method as in claim 11, wherein said derivative financial instruments comprise credit default swaps.

19. A method as in claim 11, wherein said basket comprises a second index.

20. A method as in claim 11, further comprising providing a total return swap, wherein a purchaser of said swap is guaranteed a return equivalent to that of said index.

21. A method comprising offering a total return swap for sale, wherein said total return swap is as in claim 20.

22. A method comprising offering a basket of derivative financial instruments for sale, wherein said basket of derivative financial instruments is as in claim 11.
